(19) United States
(12) Patent Application Publication
(10) Pub. No.: US 2018/0158462 A1
(43) Pub. Date: Jun. 7, 2018

(54) SPEAKER IDENTIFICATION

(71) Applicant: Cirrus Logic International Semiconductor Ltd., Edinburgh (GB)

(72) Inventors: Michael PAGE, Stonehouse Gloucestershire (GB); Carlos VAQUERO AVILÉS-CASCO, Madrid (ES)

(73) Assignee: Cirrus Logic International Semiconductor Ltd., Edinburgh (GB)

(21) Appl. No.: 15/828,592

(22) Filed: Dec. 1, 2017

Related U.S. Application Data
(60) Provisional application No. 62/429,196, filed on Dec. 2, 2016.

(30) Foreign Application Priority Data
May 4, 2017 (GB) 1707094.7

(51) Int. Cl. G10L 17/00; G10L 17/22; G10L 17/08; G10L 17/12; G06F 21/32

(52) U.S. Cl. CPC G10L 17/005; G10L 17/22; H04W 12/06; G10L 17/12; G06F 21/32; G10L 17/08

(57) ABSTRACT

A method of operation of a speaker recognition system comprises: performing a speaker recognition process on a received signal; disabling the speaker recognition process when a first speaker has been identified; performing a speech start recognition process on the received signal when the speaker recognition process is disabled; and enabling the speaker recognition process in response to the speech start recognition process detecting a speech start event in the received signal.

### FIELD OF DISCLOSURE

The field of representative embodiments of this disclosure relates to methods, apparatus and/or implementations concerning or relating to speaker identification, that is, to the automatic identification of one or more speaker in passages of speech.

### BACKGROUND

Voice biometric techniques are used for speaker recognition, and one use of this technique is in a voice capture device. Such a device detects sounds using one or more microphones, and determines who is speaking at any time. The device typically also performs a speech recognition process. Information about who is speaking may then be used, for example to decide whether to respond to spoken commands, or to decide how to respond to spoken commands, or to annotate a transcript of the speech. The device may also perform other functions, such as telephony functions and/or speech recording.

However, performing speaker recognition consumes power.

### SUMMARY

Embodiments of the present disclosure relate to methods and apparatus that may help to reduce this power consumption.

Thus according to the present invention there is provided a method of operation of a speaker recognition system, the method comprising: performing a speaker recognition process on a received signal; disabling the speaker recognition process when a first speaker has been identified; performing a speech start recognition process on the received signal when the speaker recognition process is disabled; and enabling the speaker recognition process in response to the speech start recognition process detecting a speech start event in the received signal.

Also according to the present invention there is provided a method of operation of a speaker recognition system, the method comprising: receiving data representing speech; and at a plurality of successive times: using all of the data received from a start time up until that time, obtaining a match score representing a confidence that the speech is the speech of an enrolled user; comparing the match score with an upper threshold and a lower threshold; and if the match score is higher than the upper threshold, determining that the speech is the speech of an enrolled user and terminating the method, or, if the match score is lower than the lower threshold, determining that the speech is not the speech of the enrolled user and terminating the method.

According to other aspects of the invention, there are provided speaker recognition systems, configured to operate in accordance with either of these methods, and computer program products, comprising a computer readable medium containing instructions for causing a processor to perform either of these methods.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates a smartphone configured for operating as a voice capture device.

FIG. 2 illustrates a dedicated voice capture device.

FIG. 3 is a schematic illustration of the voice capture device.

FIG. 4 is a time history showing the course of various processes.

FIG. 5 is a flow chart, illustrating a method of speaker recognition.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

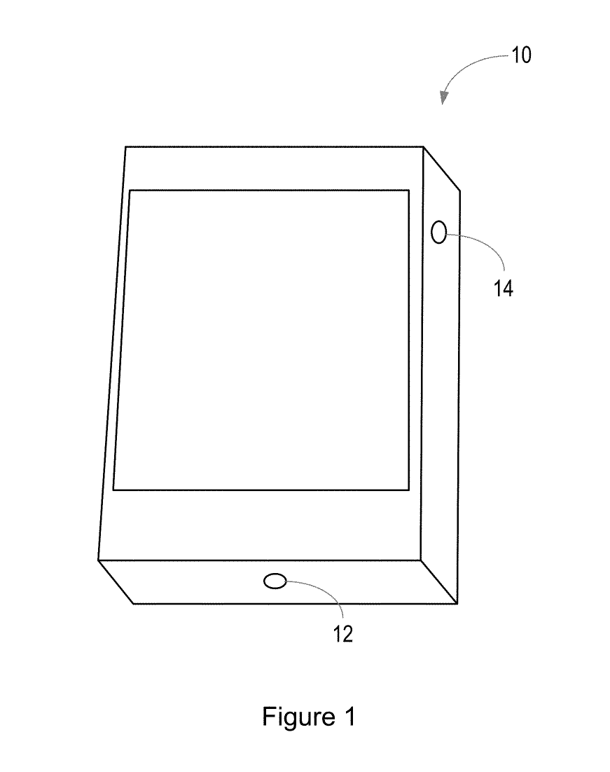

FIG. 1 illustrates one example of an electronic device 10, such as a smartphone or other mobile telephone, or a tablet computer for example.

In the example shown in FIG. 1, the device 10 has multiple sound inlets 12, 14, which allow microphones (not shown in FIG. 1) to detect ambient sounds. The device may have more than two such microphones, for example located on other surfaces of the device.

The electronic device 10 may be provided with suitable software, either as part of its standard operating software or downloaded separately, allowing it to operate as a voice capture device, as described in more detail below.

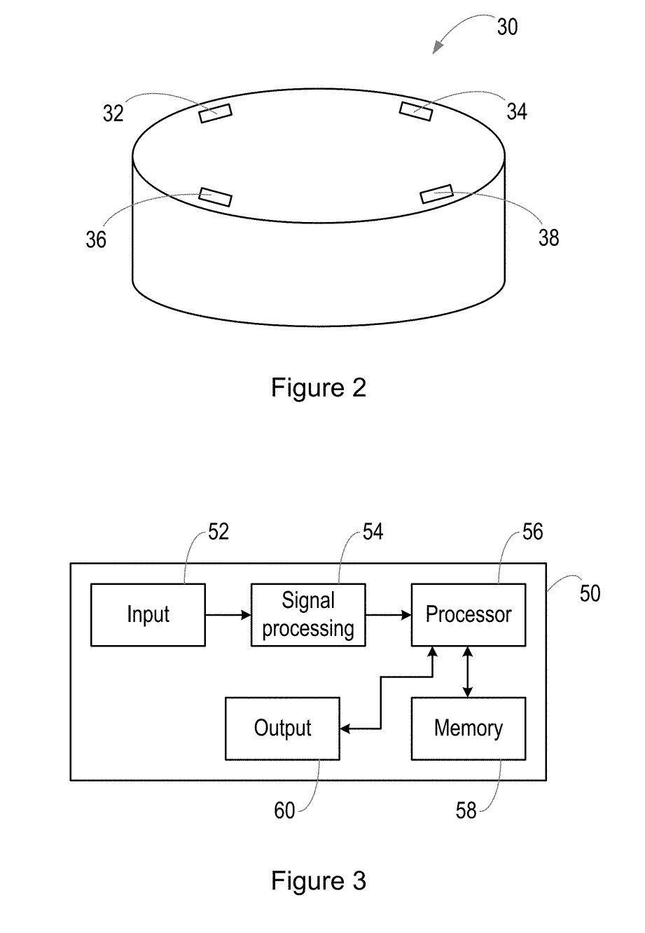

FIG. 2 illustrates one example of a dedicated voice capture device 30.

In the example shown in FIG. 1, the device 30 has multiple sound inlets 32, 34, 36, 38 located around the periphery thereof, which allow microphones (not shown in FIG. 2) to detect ambient sounds. The device may have any number of such microphones, either more or fewer than the four in the example of FIG. 2.

The voice capture device 10 is provided with suitable software, as described in more detail below.

FIG. 3 is a schematic block diagram, illustrating the general form of a device 50 in accordance with embodiments of the invention, which may for example be an electronic device 10 as shown in FIG. 1 or a voice capture device 30 as shown in FIG. 2.

The device 50 has an input module 52, for receiving or generating electronic signals representing sounds. In devices such as those shown in FIGS. 1 and 2, the input module may include the microphone or microphones that are positioned in such a way that they detect the ambient sounds. In other devices, the input module may be a source of signals representing sounds that are detected at a different location, either in real time or at an earlier time.

Thus, in the case of a device 50 in the form of a smartphone as shown in FIG. 1, the input module may include one or more microphone to detect sounds in the vicinity of the device. This allows the device to be positioned in the vicinity of a number of participants in a conversation, and act as a voice capture device to identify one or more of those participants. The input module may additionally or alternatively include a connection to radio transceiver circuitry of the smartphone, allowing the device to act as a voice capture device to identify one or more of the participants in a conference call held using the phone.

The device 50 also has a signal processing module 54, for performing any necessary signal processing to put the received or generated electronic signals into a suitable form for subsequent processing. If the input module generates analog electronic signals, then the signal processing module 54 may contain an analog-digital converter, at least. In some embodiments, the signal processing module 54 may also contain equalizers for acoustic compensation, and/or noise reduction processing, for example.

The device 50 also has a processor module 56, for performing a speaker recognition process as described in more detail below. The processor module 56 is connected to one or more memory module 58, which stores program instructions to be acted upon by the processor 56, and also stores working data where necessary.

The processor module 56 is also connected to an output module 60, which may for example include a display, such as a screen of the device 50, or which may include transceiver circuitry for transmitting information over a wired or wireless link to a separate device.

The embodiments described herein are concerned primarily with a speaker recognition process, in which the identity of a person speaking is determined. In these embodiments, the speaker recognition process is partly or wholly performed in the processor module, though it may also be performed partly or wholly in a remote device. The speaker recognition process can conveniently be performed in conjunction with a speech recognition process, in which the content of the speech is determined. Thus, for example, the processor module 56 may be configured for performing a speech recognition process, or the received signals may be sent to the output module 60 for transmission to a remote server for that remote server to perform speech recognition in the cloud.

As used herein, the term ‘module’ shall be used to at least refer to a functional unit or block of an apparatus or device. The functional unit or block may be implemented at least partly by dedicated hardware components such as custom defined circuitry and/or at least partly be implemented by one or more software processors or appropriate code running on a suitable general purpose processor or the like. A module may itself comprise other modules or functional units.

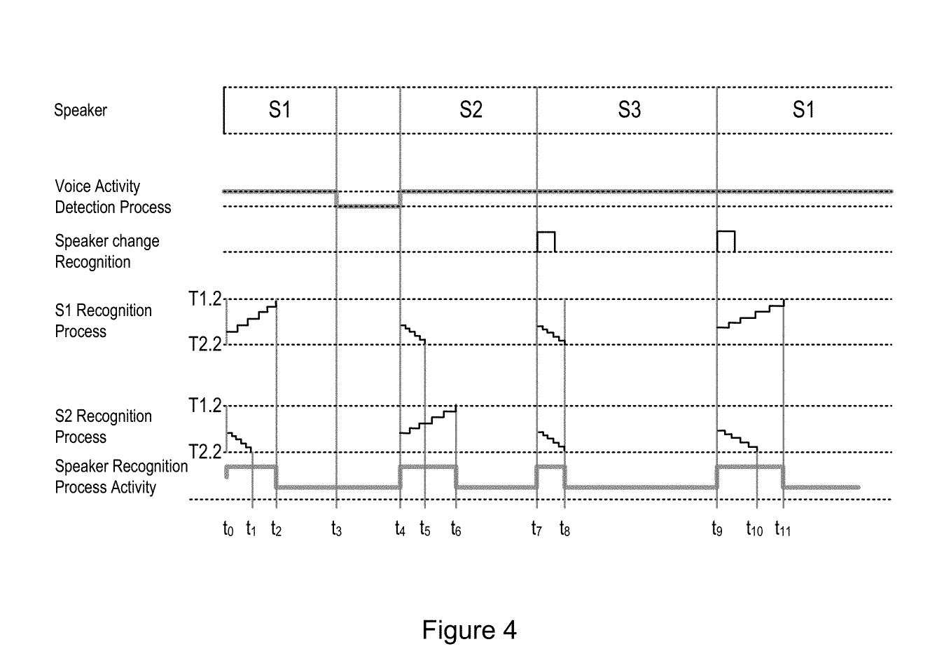

FIG. 4 shows a time history of various processes operating in the device 50 in one example. In this example, it is assumed that the device 50 is a smartphone having suitable software allowing it to operate as a voice capture device, and specifically allowing it to recognize one or more person speaking in a conversation that can be detected by the microphone or microphones of the device.

Specifically, FIG. 4 shows which of various speakers are speaking in the conversation at different times. In this illustrative example, there are three speakers, S1, S2 and S3, and speakers S1 and S2 are enrolled. That is, speakers S1 and S2 have provided samples of their speech, allowing a speaker recognition process to form models of their voices, as is conventional. There may be any number of enrolled speakers.

FIG. 4 illustrates the result of a voice activity detection process. The voice activity detection process receives the signals detected by the microphone or microphones of the device, and determines when these signals represent speech. More specifically, the voice activity detection process determines when these signals have characteristics (for example a signal-to-noise ratio or spectral characteristics) that are required in order to allow a speaker recognition process to function with adequate accuracy.

FIG. 4 also illustrates the result of a speaker change recognition process. The speaker change recognition process receives the signals detected by the microphone or microphones of the device, and determines from these signals times when one person stops speaking and another person starts speaking. For example, this determination may be made based on a determination that the spectral content of the signals has changed in a way that is unlikely during the speech of a single person. Alternatively, or additionally, in the case where the speaker change recognition process receives signals detected by multiple microphones, the location of a sound source can be estimated based on differences between the arrival times of the sound at the microphones. The determination that one person has stopped speaking and another person has started speaking may therefore be made based on a determination that the location of the sound source has changed in an abrupt manner.

It was mentioned above that the speaker recognition process may be performed partly in the processor module, and partly in a remote device. In one specific example, the speaker change recognition process may be performed remotely, in the cloud, while other aspects of the overall process are performed in the processor module.

The voice activity detection process and the speaker change recognition process can together be regarded as a speech start recognition process, as together they recognize the start of a new speech segment by a particular speaker.

FIG. 4 illustrates an example in which the speaker recognition process that is performed uses cumulative authentication. That is, the received signal is used to produce a match score, which represents a degree of certainty that the speech is the speech of the relevant enrolled speaker. As the received signal continues, the match score is updated, to represent a higher degree of certainty as to whether the speech is the speech of the relevant enrolled speaker. Thus, in one embodiment, when signals are received that are considered to represent speech, various features are extracted from the signals to form a feature vector. This feature vector is compared with the model of the or each enrolled speaker. As mentioned above, there may be any number of enrolled speakers.

The or each comparison produces a match score, which represents a degree of certainty that the speech is the speech of the relevant enrolled speaker. A value of the match score is produced as soon as sufficient samples of the signal have been received, for example after 1 second, but such short speech segments are typically unable to produce an output with a high degree of certainty. However, at regular intervals as time progresses, and more samples have become available for use in the comparison, the match score can be updated, and the degree of certainty in the result will tend to increase over time. Thus, in some embodiments, at successive times, all of the data received from a start time up until that time is used to obtain a score representing a confidence that the speech is the speech of an enrolled user. In other embodiments, the score is obtained using some of the received samples of the data, for example a predetermined number of the most recently received samples of the data. In any event, the process of updating the score may comprise performing a biometric process on all of the data that is being used, to obtain a new single score. Alternatively, the process of updating the score may comprise performing a biometric process on the most recently received data to obtain a new score relating to that data, and then fusing that score with the current value of the score to obtain a new score.

For each enrolled user, the process may continue until either the score becomes higher than an upper threshold, in which case it can be determined that the speech is the speech of an enrolled user and the method can be terminated, or the score becomes lower than a lower threshold, in which case it can be determined that the speech is not the speech of the enrolled user. The process can also then be terminated once it has been determined that the speech is not the speech of any enrolled user.

Thus, FIG. 4 illustrates the progress of the match scores produced by the two speaker recognition processes over time, namely the speaker recognition process that compares the received signal with the model of the enrolled speaker S1, and the speaker recognition process that compares the received signal with the model of the enrolled speaker S2.

FIG. 4 also indicates the times during which the speaker recognition process is active.

The time history shown in FIG. 4 starts at the time t₀. At this time, the speaker S1 starts speaking. Thus, the voice activity detection process is able to determine that the received signal contains speech, and the voice activity detection process produces a positive output.

As a result, also at time t₀, the two speaker recognition processes start. More specifically, in the S1 recognition process, the feature vector derived from the received signals is compared with the model of the enrolled speaker S1 while, in the S2 recognition process, the feature vector derived from the received signals is compared with the model of the enrolled speaker S2. These two processes continue, with the match scores accumulating over time.

As it is the enrolled speaker S1 who is speaking, the match score produced by the S1 recognition process tends to increase over time, representing an increasing degree of certainty that the enrolled speaker S1 is speaking, while the match score produced by the S2 recognition process tends to decrease over time, representing an increasing degree of certainty that the enrolled speaker S2 is not speaking.

At the time t₁, the match score produced by the S2 recognition process reaches a lower threshold value T2.2, representing a high degree of certainty that the enrolled speaker S2 is not speaking. At this time, the S2 recognition process can be stopped. That is, the feature vector derived from the speech signals is no longer compared with the model of the enrolled speaker S2.

At the time t₂, the match score produced by the S1 recognition process reaches an upper threshold value T1.1, representing a high degree of certainty that the enrolled speaker S1 is speaking. At this time, an output can be provided, to indicate that the speaker S1 is speaking. For example, the identity of the speaker S1 can be indicated on the device 50.

If the device 50 is producing a transcript of the speech, using the speech recognition process described earlier, then that transcript can show that the speaker S1 spoke the words identified during the period from t₀ to t₂.

If the device 50 is attempting to recognize spoken commands, using the speech recognition process described earlier, then the identity of the speaker S1 can be used to determine what actions should be taken in response to any commands identified. For example, particular users may be authorized to issue only certain commands. As another example, certain spoken commands may have a meaning that depends on the identity of the speaker. For example, if the device recognizes the command “phone home”, it needs to know which user is speaking, in order to identify that user's home phone number.

The upper threshold value T1.1 can be derived from a particular false acceptance rate (FAR). Thus, depending on the degree of security and certainty required for the speaker recognition process, this false acceptance rate can be adjusted, and the upper threshold value can be adjusted accordingly.

At this time t₂, the S1 recognition process can be stopped, or disabled. As both of the speaker recognition processes have now been stopped, it is no longer necessary to extract the various features from the signals to form the feature vector.

Thus, it is only necessary to perform the speaker recognition processes up until the time when the speaker has been recognized. In a typical conversation, a speech segment from a person may typically last many seconds (for example 10-20 seconds), while biometric identification to an acceptable threshold may take only 1-2 seconds of speech, so disabling the speaker recognition process when the speaker has been identified means that the speaker recognition algorithm operates with an effective duty cycle of only 10%, reducing power consumption by 90%.

FIG. 4 therefore shows that the speaker recognition process is enabled between times t₀ and t₂.

For as long as the speaker S1 continues to speak, the speaker recognition process can remain disabled. During this time, an output can continue to be provided, as described above, to indicate that the speaker S1 is speaking, or other actions can be taken on the assumption that it is still the speaker S1 who is speaking.

At the time t₃, the speaker S1 stops speaking, and a period of no speech (either silence or ambient noise) follows. During this period, the voice activity detection process determines that the received signal contains no speech, and the voice activity detection process produces a negative output. Thus, the speaker recognition process remains disabled after time t₃.

At the time t₄, the speaker S2 starts speaking. Thus, the voice activity detection process is able to determine that the received signal contains speech, and the voice activity detection process produces a positive output.

In response to this positive determination by the voice activity detection process of the speech start recognition process, also at time t₄, the two speaker recognition processes are started, or enabled. More specifically, in the S1 recognition process, the feature vector derived from the received signals is compared with the model of the enrolled speaker S1 while, in the S2 recognition process, the feature vector derived from the received signals is compared with the model of the enrolled speaker S2. These two processes continue, with the match scores accumulating over time.

As it is the enrolled speaker S2 who is speaking, the match score produced by the S1 recognition process tends to decrease over time, representing an increasing degree of certainty that the enrolled speaker S1 is not speaking, while the match score produced by the S2 recognition process tends to increase over time, representing an increasing degree of certainty that the enrolled speaker S2 is speaking.

At the time t₅, the match score produced by the S1 recognition process reaches a lower threshold value T2.1, representing a high degree of certainty that the enrolled speaker S1 is not speaking. At this time, the S1 recognition process can be stopped. That is, the feature vector derived from the speech signals is no longer compared with the model of the enrolled speaker S1.

At the time t₆, the match score produced by the S2 recognition process reaches an upper threshold value T1.2, representing a high degree of certainty that the enrolled speaker S2 is speaking. At this time, an output can be provided, to indicate that the speaker S2 is speaking. For example, the identity of the speaker S2 can be indicated on the device 50.

If the device 50 is producing a transcript of the speech, using the speech recognition process described earlier, then that transcript can show that the speaker S2 spoke the words identified during the period from t₄ to t₆.

If the device 50 is attempting to recognize spoken commands, using the speech recognition process described earlier, then the identity of the speaker S2 can be used to determine what actions should be taken in response to any commands identified, as described previously for the speaker S1.

The upper threshold value T1.2 can be derived from a particular false acceptance rate (FAR). Thus, depending on the degree of security and certainty required for the speaker recognition process, this false acceptance rate can be adjusted, and the upper threshold value can be adjusted accordingly. The upper threshold value T1.2 applied by the S2 recognition process can be the same as the upper threshold value T1.2 applied by the S1 recognition process, or can be different.

At this time t₆, the S2 recognition process can be stopped, or disabled. As both of the speaker recognition processes have now been stopped, it is no longer necessary to extract the various features from the signals to form the feature vector.

Thus, as before, it is only necessary to perform the speaker recognition processes up until the time when the speaker has been recognized. Specifically, FIG. 4 shows that the speaker recognition process is enabled between times t₄ and t₆, but disabled thereafter.

For as long as the speaker S2 continues to speak, the speaker recognition process can remain disabled. During this time, an output can continue to be provided, as described above, to indicate that the speaker S1 is speaking, or other actions can be taken on the assumption that it is still the speaker S1 who is speaking.

At the time t₇, the speaker S2 stops speaking, and the non-enrolled speaker S3 starts speaking. The voice activity detection process determines that the received signal continues to contain speech, and the voice activity detection process produces a positive output.

Further, the speaker change recognition process determines that there has been a change of speaker, and the speaker change recognition process produces a positive output.

In response to this positive determination by the speaker change recognition process of the speech start recognition process, also at time t₇, the two speaker recognition processes are started, or enabled.

More specifically, in the S1 recognition process, the feature vector derived from the received signals is compared with the model of the enrolled speaker S1 while, in the S2 recognition process, the feature vector derived from the received signals is compared with the model of the enrolled speaker S2. These two processes continue, with the match scores accumulating over time.

As neither of the enrolled speakers S1 or S2 is speaking, the match scores produced by the S1 recognition process and by the S2 recognition process both tend to decrease over time, respectively representing an increasing degree of certainty that the enrolled speaker S1 is not speaking, and an increasing degree of certainty that the enrolled speaker S2 is not speaking.

At the time t₈, the match score produced by the S1 recognition process reaches a lower threshold value T2.1, representing a high degree of certainty that the enrolled speaker S1 is not speaking, and the match score produced by the S2 recognition process reaches a lower threshold value T2.2, representing a high degree of certainty that the enrolled speaker S2 is not speaking. At this time, the S1 recognition process and the S2 recognition process can both be stopped, or disabled.

As both of the speaker recognition processes have now been stopped, it is no longer necessary to extract the various features from the signals to form the feature vector.

Thus, as before, it is only necessary to perform the speaker recognition processes up until the time when the speaker has been recognized. FIG. 4 therefore shows that the speaker recognition process is enabled between times t₇ and t₈, but disabled thereafter.

At the time t₈, an output can be provided, to indicate that the person speaking is not one of the enrolled speakers. For example, this indication can be provided on the device 50.

If the device 50 is producing a transcript of the speech, using the speech recognition process described earlier, then that transcript can show that an non-enrolled speaker spoke the words identified during the period from t₇ to t₈.

If the device 50 is attempting to recognize spoken commands, using the speech recognition process described earlier, then the fact that the speaker S3 could not be identified can be used to determine what actions should be taken in response to any commands identified. For example, any commands that require any degree of security authorization may be ignored.

For as long as the speaker S3 continues to speak, the speaker recognition process can remain disabled. During this time, an output can continue to be provided, as described above, to indicate that the non-enrolled speaker is speaking, or other actions can be taken on the assumption that it is still the non-enrolled speaker who is speaking.

At the time t₉, the non-enrolled speaker S3 stops speaking, and the speaker S1 starts speaking. The voice activity detection process determines that the received signal continues to contain speech, and the voice activity detection process produces a positive output.

Further, the speaker change recognition process determines that there has been a change of speaker, and the speaker change recognition process produces a positive output.

In response to this positive determination by the speaker change recognition process of the speech start recognition process, also at time t₉, the two speaker recognition processes are enabled.

More specifically, in the S1 recognition process, the feature vector derived from the received signals is compared with the model of the enrolled speaker S1 while, in the S2 recognition process, the feature vector derived from the received signals is compared with the model of the enrolled speaker S2. These two processes continue, with the match scores accumulating over time.

As it is the enrolled speaker S1 who is speaking, the match score produced by the S1 recognition process tends to increase over time, representing an increasing degree of certainty that the enrolled speaker S1 is speaking, while the match score produced by the S2 recognition process tends to decrease over time, representing an increasing degree of certainty that the enrolled speaker S2 is not speaking.

At the time t₁₀, the match score produced by the S2 recognition process reaches a lower threshold value T2.2, representing a high degree of certainty that the enrolled speaker S2 is not speaking. At this time, the S2 recognition process can be stopped, or disabled. That is, the feature vector derived from the speech signals is no longer compared with the model of the enrolled speaker S2.

At the time t₁₁, the match score produced by the S1 recognition process reaches an upper threshold value T1.1, representing a high degree of certainty that the enrolled speaker S1 is speaking. At this time, an output can be provided, to indicate that the speaker S1 is speaking. For example, the identity of the speaker S1 can be indicated on the device 50, a transcript of the speech can show that the speaker S1 spoke the words identified during the period from t₁₀ to t₁₁, a spoken command can be dealt with on the assumption that the speaker S1 spoke the command, or any other required action can be taken.

At this time t₁₁, the S1 recognition process can be stopped. As both of the speaker recognition processes have now been stopped, or disabled, it is no longer necessary to extract the various features from the signals to form the feature vector.

Thus, as before, it is only necessary to perform the speaker recognition processes up until the time when the speaker has been recognized. Specifically, FIG. 4 shows that the speaker recognition process is enabled between times t₉ and t₁₁, but disabled thereafter.

For as long as the speaker S1 continues to speak, the speaker recognition process can remain disabled. During this time, an output can continue to be provided, as described above, to indicate that the speaker S1 is speaking, or other actions can be taken on the assumption that it is still the speaker S1 who is speaking.

Thus, FIG. 4 shows that the speaker recognition process is enabled between times t₀ and t₂, t₄ and t₆, t₇ and t₈, and t₉ and t₁₁, but disabled between times t₂ and t₄, to and t₇, t₈ and t₉, and after time t₁₁. During these latter time periods, it is only necessary to activate the voice activity detection process and/or the speaker change recognition process. Since these processes are much less computationally intensive than the speaker recognition process, this reduces the power consumption considerably, compared with systems in which the speaker recognition process runs continually.

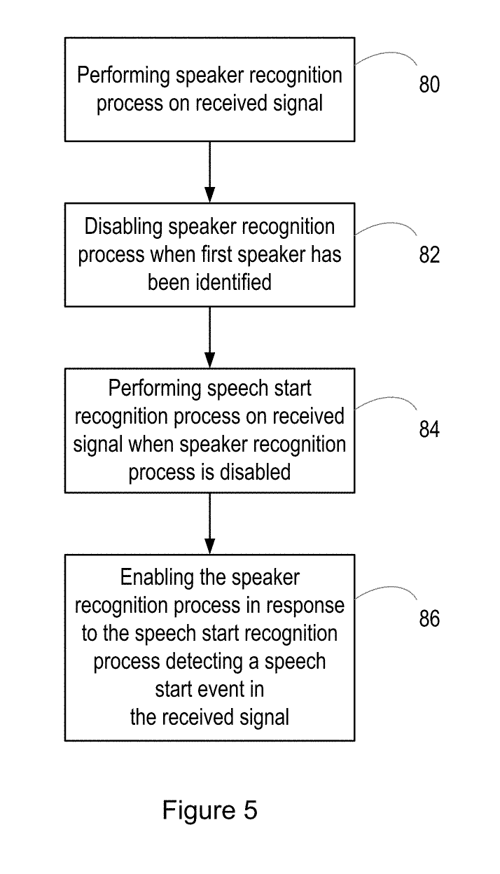

FIG. 5 is a flow chart, illustrating the method of operation of a speaker recognition system as described above, in general terms.

At step 80, a speaker recognition process is performed on a received signal.

The speaker recognition process may be a cumulative authentication process, or may be a continuous authentication process. In the case of a cumulative authentication process, performing the speaker recognition process may comprise generating a biometric match score, and identifying a speaker when the biometric match score exceeds a threshold value. The threshold value may be associated with a predetermined false acceptance rate.

At step 82, the speaker recognition process is disabled when a first speaker has been identified.

At step 84, a speech start recognition process is performed on the received signal when the speaker recognition process is disabled.

The speech start recognition process may be adapted to detect a speech start event comprising the start of speech in the received signal following a period in which the received signal does not contain speech. In that case, the speech start recognition process may be a voice activity detection process. The voice activity detection process may be configured to detect characteristics of the received signal that are required for the speaker recognition process to operate successfully.

The speech start recognition process may be adapted to detect a speech start event comprising the start of speech in the received signal by a second speaker, without a significant gap in speech between the first and second speakers. In that case, the speech start recognition process may be adapted to detect a speech start event comprising the start of speech in the received signal by a second speaker by detecting a change in a direction from which speech sounds are detected. Alternatively, or additionally, the speech start recognition process may be adapted to detect a speech start event comprising the start of speech in the received signal by a second speaker by detecting a change in a frequency content of detected speech sounds.

At step 86, the speaker recognition process is enabled in response to the speech start recognition process detecting a speech start event in the received signal.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A method of operation of a speaker recognition system, the method comprising:
performing a cumulative authentication speaker recognition process on a received signal, the cumulative authentication process comprising generating a biometric match score, updating the biometric match score as the signal is received, and identifying a first speaker when the biometric match score exceeds a first threshold value;
disabling the speaker recognition process when the first speaker has been identified;
performing a speech start recognition process on the received signal when the speaker recognition process is disabled; and
enabling the speaker recognition process in response to the speech start recognition process detecting a speech start event in the received signal.

2. A method according to claim 1, in which the speech start recognition process is adapted to detect a speech start event comprising the start of speech in the received signal following a period in which the received signal does not contain speech.

3. A method according to claim 2, in which the speech start recognition process is a voice activity detection process.

4. A method according to claim 3, in which the voice activity detection process is configured to detect characteristics of the received signal that are required for the speaker recognition process to operate successfully.

5. A method according to claim 1, in which the speech start recognition process is adapted to detect a speech start event comprising the start of speech in the received signal by a second speaker.

6. A method according to claim 5, in which the speech start recognition process is adapted to detect a speech start event comprising the start of speech in the received signal by a second speaker by detecting a change in a direction from which speech sounds are detected.

7. A method according to claim 5, in which the speech start recognition process is adapted to detect a speech start event comprising the start of speech in the received signal by a second speaker by detecting a change in a frequency content of detected speech sounds.

8. A method according to claim 1, wherein the threshold value is associated with a predetermined false acceptance rate.

9. A method as claimed in claim 1, further comprising comparing the biometric match score with a second threshold value, wherein the second threshold value is below the first threshold value, and determining that the first speaker is not speaking if the biometric match score is below the second threshold.

10. A method as claimed in claim 1, further comprising disabling the speaker recognition process in response to determining that no speaker can be identified.

11. A method of operation of a speaker recognition system, the method comprising:
receiving data representing speech; and
at a plurality of successive times:
using all of the data received from a start time up until that time, obtaining a match score representing a confidence that the speech is the speech of an enrolled user;
comparing the match score with an upper threshold and a lower threshold; and
if the match score is higher than the upper threshold, determining that the speech is the speech of an enrolled user and terminating the method, or
if the match score is lower than the lower threshold, determining that the speech is not the speech of the enrolled user and terminating the method.

12. A method as claimed in claim 11, wherein there are a plurality of enrolled users, and comprising, at the plurality of successive times:
using all of the data received up until that time, obtaining a plurality of match scores, each representing a confidence that the speech is the speech of a respective enrolled user;
comparing the match scores with a respective upper threshold and a respective lower threshold; and
if any match score is higher than the respective upper threshold, determining that the speech is the speech of the respective enrolled user and terminating the method, or
if any match score is lower than the respective lower threshold, determining that the speech is not the speech of the respective enrolled user and ceasing obtaining the match score representing the confidence that the speech is the speech of that respective enrolled user

13. A speaker recognition system, configured to operate in accordance with the method according to claim 1.

14. A computer program product, comprising a computer readable medium containing instructions for causing a processor to perform a method according to claim 1.

15. A device comprising a processor and a memory, wherein the memory stores program instructions to be acted upon by the processor, said program instructions causing the processor to perform a method according to claim 1.

16. A speaker recognition system, configured to operate in accordance with the method according to claim 11.

17. A computer program product, comprising a computer readable medium containing instructions for causing a processor to perform a method according to claim 11.

18. A device comprising a processor and a memory, wherein the memory stores program instructions to be acted upon by the processor, said program instructions causing the processor to perform a method according to claim 11.
